(19) United States
(12) Patent Application Publication
(10) Pub. No.: US 2011/0001726 A1
(43) Pub. Date: Jan. 6, 2011

(54) AUTOMATICALLY CONFIGURABLE HUMAN MACHINE INTERFACE SYSTEM WITH INTERCHANGEABLE USER INTERFACE PANELS

(76) Inventors: Thomas John Buckingham, Novi, MI (US); David Michael Whitton, Saline, MI (US)

Correspondence Address: FRASER CLEMENS MARTIN & MILLER LLC, 28366 KENSINGTON LANE, PERRYSBURG, OH, 43551, US

(21) Appl. No.: 12/497,874

(22) Filed: Jul. 6, 2009

(51) Int. Cl. G06F 3/042; G06F 3/033

(52) U.S. Cl. 345/175; 715/863

(57) ABSTRACT

A human machine interface system is disclosed. The human machine interface system includes a sensing portion adapted to detect a presence and a location of a touch, a user input portion releasably coupled to the sensing portion, wherein the user input portion includes an indicia representing a control function associated with the sensing portion, and a controller in communication with the sensing portion for configuring the control function associated with the sensing portion based upon the user input portion.

### FIELD OF THE INVENTION

The present invention relates to a Human Machine Interface (HMI) system. More particularly, the invention is directed to a HMI system including a plurality of interchangeable user interface panels.

### BACKGROUND OF THE INVENTION

Automotive OEM's and suppliers are trying to develop and improve vehicle interiors with controls that are as easy as possible for drivers and passengers to access and operate. These efforts, focused on the quality of the HMI (Human-Machine Interface), cover items such as the location and function of the user input areas (historically this would have been buttons and/or knobs), and also methods to selectively associate certain input areas with certain functions through selective and/or reconfigurable illumination. Once the location of the input area is determined (typically by the OEM), only a possibility of a function change remains.

There are numerous patents outlining reconfigurable control panels. Certain patents describe methods for changing lighting or function of the user interface points. For example, U.S. Pat. No. 6,529,125 describes a control panel for a vehicle with “at least one” multifunctional setting switch and mode selector for manually selecting between at least two modes. Lighting variations are used to display the input areas on the selected mode. However, automatic reconfiguration of user input panels for function and location is not discussed.

As a further example, the following patents illustrate the state of existing and known technology with regard to configurable panels and HMI:

European Pat. No. 0854 798 describes a driver control Interface system including selectively activated feature groups that can incorporate subsets of feature groups allowing for customization/personalization;

U.S. Pat. No. 6,441,510 discloses a reconfigurable modular instrument cluster arrangement including a configurable instrument panel that allows for configuration to be made “late in the assembly process”; and

U.S. Pat. Nos. 5,999,104 and 6,005,488 describe a User Control Interface Architecture for Automotive Electronic Systems and a Method of Producing Customizable Automotive Electronic Systems to allow minor changes to user control HMI without modifying the control software.

None of the efforts to date have allowed an end user to position or locate his/her input areas and have the control panel automatically reconfigure to understand and accept the input area's new position.

It would be desirable to develop a human machine interface system and a method for automatic configuration of the human machine interface system, wherein the system and method each provide an automatic reconfiguration of a control function of a sensing portion based upon at least one of a type, a position, and an orientation of a user input portion relative to the sensing portion.

### SUMMARY OF THE INVENTION

Concordant and consistent with the present invention, a human machine interface system and a method for automatic configuration of the human machine interface system, wherein the system and method each provide an automatic reconfiguration of a control function of a sensing portion based upon at least one of a type, a position, and an orientation of a user input portion relative to the sensing portion, has surprisingly been discovered.

In one embodiment, a human machine interface system comprises: a sensing portion adapted to detect a presence and a location of a touch; a user input portion releasably coupled to the sensing portion, wherein the user input portion includes an indicia representing a control function associated with the sensing portion; and a controller in communication with the sensing portion for configuring the control function associated with the sensing portion based upon the user input portion.

In another embodiment, A human machine interface system for controlling a vehicle system, the human machine interface comprises: a sensing portion adapted to detect a presence and a location of a touch; a user input portion releasably coupled to the sensing portion, wherein the user input portion includes an indicia representing a control function associated with the sensing portion, a panel identification feature, and an orientation reference feature; a controller in communication with the sensing portion for configuring the control function associated with the sensing portion based upon at least one of the panel identification feature and the orientation reference feature.

The invention also provides methods for automatic configuration of a human machine interface system.

One method comprises the steps of providing a sensing portion adapted to detect a presence and a location of a touch; providing a user input portion releasably coupled to the sensing portion, wherein the user input portion includes an indicia representing a control function associated with the sensing portion, a panel identification feature, and an orientation reference feature; detecting the panel identification feature; detecting the orientation reference feature; and configuring the control function associated with the sensing portion based upon at least one of the panel identification feature and the orientation reference feature.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a fragmentary perspective view of an interior of a vehicle including a human machine interface according to an embodiment of the present invention; and

FIG. 2 is a schematic diagram of the human machine interface of FIG. 1, showing the human machine interface in communication with a vehicle system.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

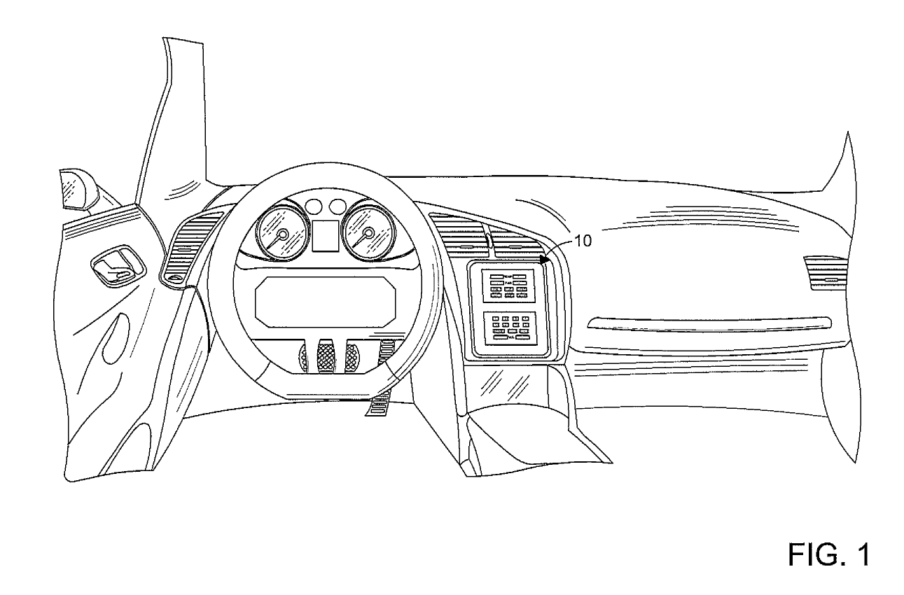

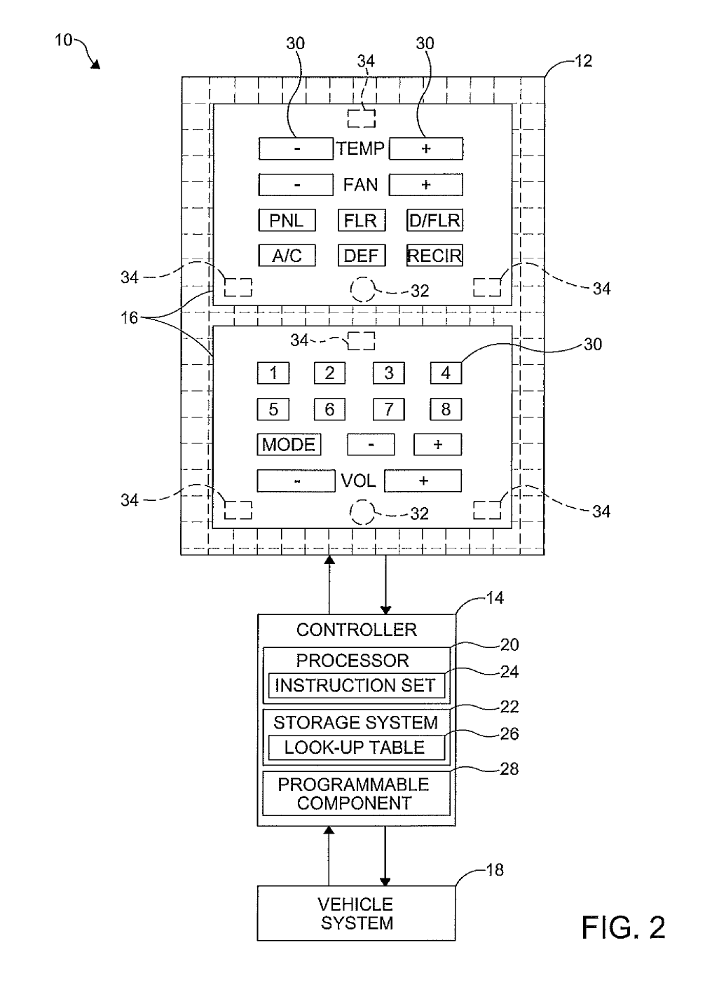

FIGS. 1 and 2 illustrate a human machine interface system (HMI) 10 disposed in a center stack of a vehicle according to an embodiment of the present invention. However, the HMI 10 may be disposed in any position and used in other applications, as desired. As shown, the HMI 10 includes a sensing portion 12, a controller 14, and a plurality of user input portions 16. In the embodiment shown, the HMI 10 is in communication with a vehicle system 18. It is understood that the vehicle system 18 may be any user controlled system such as an audio system, a climate control system, a navigation system, a video system, a vehicle information system, a trip computer, and a driver awareness system, for example. Other systems may also be controlled by the HMI 10. It is further understood that any number of sensing portions, controllers, and user input portions may be used.

The sensing portion 12 is typically a touch-sensitive portion adapted to detect a presence and a location of a touch (finger or stylus) within a pre-defined sensing area and generate a sensing signal representing at least the location of the sensed touch. It is understood that any touch-sensing technology may be used such as capacitive sensing, inductive sensing, infrared sensing, acoustic sensing, and optical sensing, for example. It is further understood that the sensing portion 12 may be integrated with any surface of the vehicle. As a non-limiting example, the sensing portion 12 is shown integrated in the center stack of the vehicle. However, any surface, flat or curved, may include the sensing portion 12.

The controller 14 is adapted to receive the sensing signal, analyze the sensing signal, and control at least one vehicle system 18 in response to the analysis of the sensing signal. In certain embodiments, the controller 14 includes a processor 20 and a storage system 22. The processor 20 is adapted to analyze the sensing signal based upon an instruction set 24. The instruction set 24, which may be embodied within any computer readable medium, includes processor executable instructions for configuring the processor 20 to perform a variety of tasks. The storage system 22 may be a single storage device or may be multiple storage devices. Portions of the storage system 22 may also be located on the processor 20. Furthermore, the storage system 22 may be a solid state storage system, a magnetic storage system, an optical storage system, or any other suitable storage system. It is understood that the storage system 22 is adapted to store the instruction set 24. Other data and information may be stored in the storage system 22, as desired.

A function identifier lookup table 26 is also stored in reprogrammable memory of the storage system 22. The lookup table 26 contains a mapping of the sensing signals to specific function identification codes associated with the control functions of the sensing portion 12. It is understood that reprogramming the lookup table 26 modifies the control functions and architecture of the HMI 10.

The controller 14 may further include a programmable component 28. The programmable component 28 is in communication with the processor 20. It is understood that the programmable component 28 may be in communication with any other component such as the vehicle system 18 and the storage system 22, for example. In certain embodiments, the programmable component 28 is adapted to manage and control processing functions of the processor 20. Specifically, the programmable component 28 is adapted to control the analysis of the sensing signal. It is understood that the programmable component 28 may be adapted to manage and control the vehicle system 18. It is further understood that the programmable component 28 may be adapted to store data and information on the storage system 22 and retrieve data and information from the storage system 22. Where the controller 14 includes a programmable component 28, the analysis of the sensing signal by the controller 14 may be pre-programmed. It is understood that the analysis of the sensing signal may be adjusted in real-time or pre-programmed by the original equipment manufacturer (OEM) or user. It is further understood that the functions of the controller 14 may have stored settings that may be recalled and processed, as desired.

The user input portions 16 are typically laminate appliqués having a plurality of graphical indicia 30 to represent particular control functions associated with the sensing portion 12. For example, the user input portion 16 may have indicia relating to audio controls. As another example, the user input portion 16 may have indicia relating to climate controls. It is understood that the user input portion 16 may have any indicia relating to the control of the vehicle system 18. As a non-limiting example, the user input portions 16 may be formed from molded plastics, formed material (rubber, plastic sheet stock or machined materials (wood etc) or fabric supported by a substructure. Other rigid and flexible materials may be used.

As more clearly illustrated in FIG. 2, the user input portions 16 further include a panel identification feature 32, and orientation reference features 34. The panel identification feature 32 represents information relating to the type, structure, shape, and indicia of the user input portion 16. It is understood that each of a plurality of the user input portions 16 may have unique panel identification features 32. In certain embodiments, the panel identification feature 32 is a plurality of sensor-readable points or elements disposed on a sensor side of the user input portion 16. The panel identification feature 32 is detected and analyzed or “read” by the underlying sensor portion 12. As a non-limiting example, the panel identification feature 32 is at least one of an infrared-readable bar code written with infrared inks on a surface of the user input portion 16 and a conductive or metallic pattern that can be detected by an inductive or capacitive sensing surface. It is understood that other inks, points, patterns, and elements may be used such as an optical-readable indicia, for example.

As shown, three orientation reference features 34 are included, wherein each orientation reference feature 34 is readable by the specific underlying sensing system 12. However, any number of orientation reference features 34 may be used. As a non-limiting example, the orientation reference features 34 are at least one of an infrared-readable indicia, a conductive pattern, and an optical indicia. The orientation reference features 34 are disposed on a sensor-facing side of the user input portion 16 to provide a positional reference point for determining an angular rotation of the user input portion 16. It is understood that the orientation reference features 34 may include any number of points or indicia.

In use, the user input portion 16 is releasably coupled to the sensing portion 12. It is understood that the user input portion 16 may be coupled to the sensing portion 12 using various pressure sensitive adhesives, a mechanical pressure method, and a magnetic coupling means. Other coupling means may be used, provided the coupling means does not interfere with the sensing technology of the sensing portion 12. Once coupled, the sensing portion 12 detects a location, orientation, and type of the user input portion 16 by sensing the panel identification feature 32 and the orientation features 34. Specifically, a sensing signal is transmitted by the sensing portion 12 to the controller 14. The controller 14 processes the sensor signal including the information detected from the panel identification feature 32 and the orientation reference features 34. The controller 14 adjusts the control function of the sensing portion 12 in response to the particular user input panel 16 that is coupled to the sensing portion 12. In particular, the controller 14 adjusts the control function of the sensing portion 12 in response to the user identification feature 32 and the orientation reference features 34. It is understood that any number of user input portions 16 may be coupled to the sensing portion 12 and detected thereby.

In certain embodiments, the sensing signal is used as an address for pointing to a location within a function identifier lookup table 26 for modifying the control function of the sensing portion 12. For example, the lookup table 26 is pre-programmed with a control function identification code which identifies a desired adjustment to the vehicle system 18 in response to the activation of the control function of the sensing portion 12 by the user.

As a non-limiting example, one of the user input portions 16 may be associated with an audio control function, and therefore, the panel identification feature 32 represents the audio control function. As such, when the user input portion 16 representing audio control is coupled to the sensing portion 12, the sensing portion 12 detects the panel identification feature 32 and the controller 14 modifies the control function of the sensing portion 12 to match the structure and functional representation of the user input portion 16 (e.g. audio control).

This invention is distinguished from others because it allows for an automatically configurable HMI. The invention allows the user to place the user input portions 16 anywhere in a predetermined area associated with the sensing portion 12. The type, location, and orientation of the user input portion 16 is sensed and the sensing portion 12, controller 14, and vehicle system 18 are automatically configured to cooperate appropriately when a desired control function is selected.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A human machine interface system comprising:
a sensing portion adapted to detect a presence and a location of a touch;
a user input portion releasably coupled to the sensing portion, wherein the user input portion includes an indicia representing a control function associated with the sensing portion; and
a controller in communication with the sensing portion for configuring the control function associated with the sensing portion based upon the user input portion.

2. The human machine interface system according to claim 1, wherein the sensing portion is at least one of an inductive sensing portion, a capacitive sensing portion, an infrared sensing portion, and an optical sensing portion.

3. The human machine interface system according to claim 1, wherein the user input portion includes a panel identification feature.

4. The human machine interface system according to claim 3, wherein the panel identification feature is detected by the sensing portion and the control function is configured by the controller based upon the panel identification feature.

5. The human machine interface system according to claim 1, wherein the user input portion includes an orientation reference feature.

6. The human machine interface system according to claim 5, wherein the orientation reference feature is detected by the sensing portion and the control function is configured by the controller based upon the location of the orientation reference feature.

7. The human machine interface system according to claim 1, wherein the control function associated with the sensing portion is configured based upon information stored in a look-up table.

8. The human machine interface system according to claim 1 wherein the controller includes at least one of a processor, a storage system, and a programmable component.

9. The human machine interface system according to claim 1, wherein the touch is provided by at least one of a finger of a user and a stylus.

10. A human machine interface system for controlling a vehicle system, the human machine interface comprising:
a sensing portion adapted to detect a presence and a location of a touch;
a user input portion releasably coupled to the sensing portion, wherein the user input includes an indicia representing a control function associated with the sensing portion, a panel identification feature, and an orientation reference feature; and
a controller in communication with the sensing portion for configuring the control function associated with the sensing portion based upon at least one of the panel identification feature and the orientation reference feature.

11. The human machine interface system according to claim 10, wherein the sensing portion is at least one of an inductive sensing portion, a capacitive sensing portion, an infrared sensing portion, and an optical sensing portion.

12. The human machine interface system according to claim 11, wherein the panel identification feature is detected by the sensing portion and the control function is configured by the controller based upon the panel identification feature.

13. The human machine interface system according to claim 11, wherein the orientation reference feature is detected by the sensing portion and the control function is configured by the controller based upon the location of the orientation reference feature.

14. The human machine interface system according to claim 10, wherein the control function associated with the sensing portion is configured based upon information stored in a look-up table.

15. The human machine interface system according to claim 10, wherein the controller includes at least one of a processor, a storage system, and a programmable component.

16. The human machine interface system according to claim 10, wherein the touch is provided by at least one of a finger of a user and a stylus.

17. A method for automatic configuration of a human machine interface system, the method comprising the steps of:
providing a sensing portion adapted to detect a presence and a location of a touch;
providing a user input portion releasably coupled to the sensing portion, wherein the user input includes an indicia representing a control function associated with the sensing portion, a panel identification feature, and an orientation reference feature;
detecting the panel identification feature;
detecting the orientation reference feature; and
configuring the control function associated with the sensing portion based upon at least one of the panel identification feature and the orientation reference feature.

18. The method according to claim 17, wherein the sensing portion is at least one of an inductive sensing portion, a capacitive sensing portion, an infrared sensing portion, and an optical sensing portion.

19. The method according to claim 17, wherein the panel identification feature and the orientation reference feature are each detected by the sensing portion.

20. The method according to claim 17, wherein the control function associated with the sensing portion is configured based upon information stored in a look-up table.
